(19) United States
(12) Patent Application Publication
(10) Pub. No.: US 2013/0199252 A1
(43) Pub. Date: Aug. 8, 2013

(54) ANTI-THEFT LOCK ASSEMBLY

(71) Applicant: Richard Harder, Sumner, WA (US)

(72) Inventor: Richard Harder, Sumner, WA (US)

(21) Appl. No.: 13/435,155

(22) Filed: Mar. 30, 2012

Related U.S. Application Data
(60) Provisional application No. 61/595,548, filed on Feb. 6, 2012.

(51) Int. Cl. E05B 65/00

(52) U.S. Cl. 70/57

(57) ABSTRACT

This is directed to systems, processes, and machines that protect a urinal from theft. The systems, processes, and machines can deter and prevent the theft of urinals by protecting the compression nut from being turned.

### CROSS REFERENCE TO RELATED APPLICATIONS

This application claims priority to provisional patent application 61/595,548 filed on Feb. 6, 2012.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION BY REFERENCE OF MATERIAL SUBMITTED ON A COMPACT DISC

Not Applicable

### FIELD OF THE INVENTION

This invention relates to protection of commercial urinals from theft.

### BACKGROUND OF THE INVENTION

Thieves steal metal in many secured and unsecured forms in order to sell it for scrap. For commercial urinals this is a particularly serious problem. In some restaurants, the bathrooms are located in close proximity to the door. The urinal plumbing can be removed in about 20 seconds and costs $400 to replace. The present invention makes this substantially more difficult, because it secures the urinal flush valve, the removal of which is necessary to abscond with the urinal piping.

### BRIEF SUMMARY OF THE INVENTION

The present invention includes methods, systems, and other means for an anti-theft lock assembly. The anti-theft lock assembly comprises an outer bracket mechanically coupled to an inner bracket by a hinge mechanism and a locking mechanism. The outer bracket comprises a first pin hole, a second pin hole, a first lock hole and sometimes a second lock hole. The inner bracket comprises a third pin hole, a third lock hole and sometimes a fourth pin hole and a fourth lock hole. The hinge mechanism further comprises inserting a pin through the first pin hole, second pin hole and third pin hole and permanently fixing the pin to the first pin hole and the second pin hole such that the inner bracket remains ambulatory. The locking mechanism further comprises inserting a key lock through the first lock hole into the second lock hole and activating the key lock.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of the invention shown in use.

FIG. 2 is a perspective view of the invention.

FIG. 3 is a perspective view of the outer bracket.

FIG. 4 is a perspective view of the inner bracket.

FIG. 5 is a section detail view of the invention along line 2-2 in FIG. 1.

FIG. 6 is an exploded view of the invention.

FIG. 7 is a perspective view of the alternate embodiment of the invention shown in use.

FIG. 8 is a perspective view of the alternate embodiment of the invention.

FIG. 9 is a bottom view of an alternate embodiment of the invention.

FIG. 10 is a perspective view of the alternate embodiment of the invention illustration range of rotational motion.

### DETAILED DESCRIPTION OF THE INVENTION

Embodiments of the present invention overcome many of the obstacles associated with thieves stealing urinal piping, and now will be described more fully hereinafter with reference to the accompanying drawings that show some, but not all embodiments of the claimed inventions. Indeed, the invention may be embodied in many different forms and should not be construed as limited to the embodiments set forth herein. Rather, these embodiments are provided so that this disclosure will satisfy applicable legal requirements. Like numbers refer to like elements throughout.

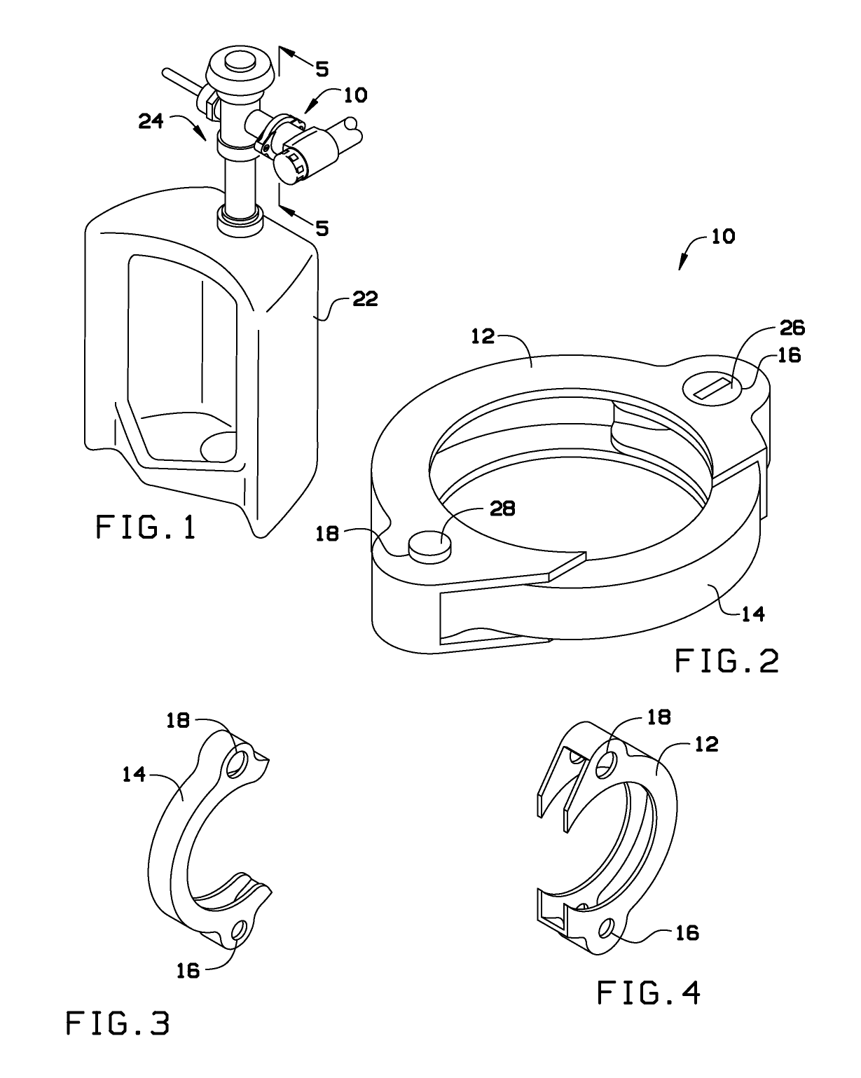

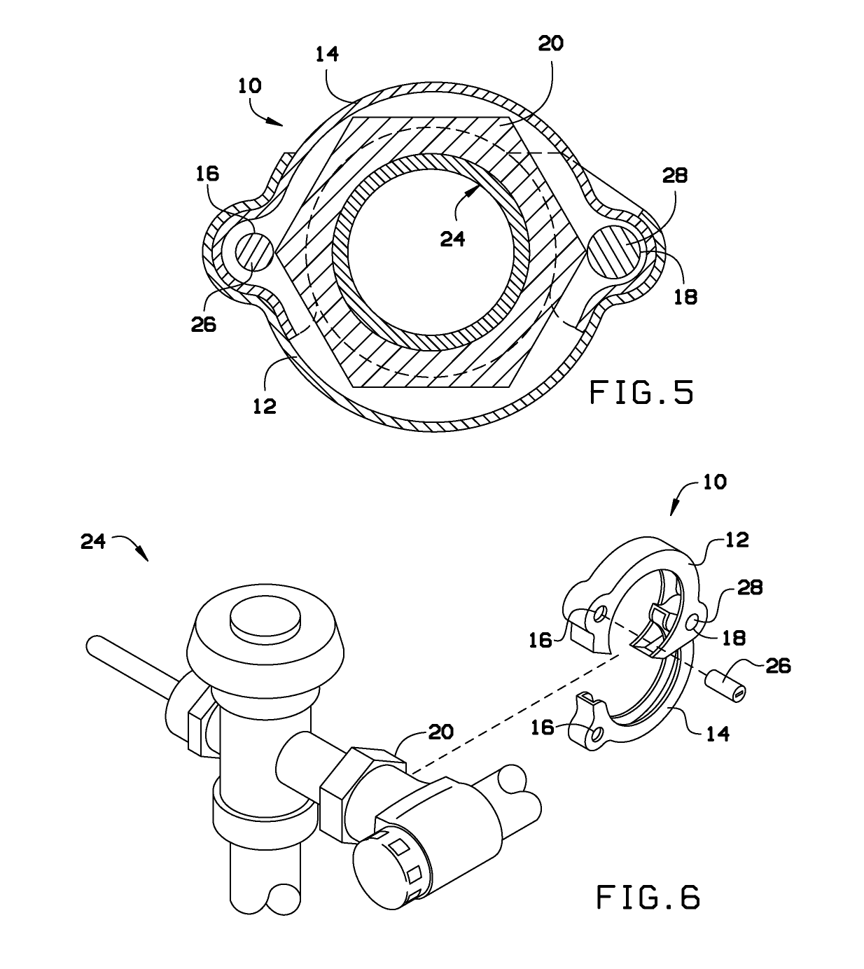

FIG. 1 shows a perspective view of the invention in use. Urinal 22 is connected to a water source by urinal piping 24. Thieves desire to steal urinal piping 24 because it can be sold for scrap. The owner of urinal 22 and urinal piping 24 desires to protect urinal piping 24 to avoid replacement costs. The owner can accomplish this goal by covering compression nut 20 (not shown) with anti-theft lock assembly 10 as shown in FIG. 6.

FIG. 2 shows anti-theft lock assembly 10 in more detail. Anti-theft lock assembly 10 comprises outer bracket 12 (shown in more detail in FIG. 3), which is mechanically coupled to inner bracket 14 (shown in more detail in FIG. 4) by a hinge mechanism and a locking mechanism. The hinge mechanism involves inserting key bolt 26 through first key bolt hole 16, second key bolt hole 16, third key bolt hole 16 and fourth key bolt hole 16 as shown below. The locking mechanism involves inserting pin 28 through first pin hole 18, second pin hole 18, third pin hole 18 and fourth pin hole 18.

FIG. 3 shows inner bracket 14 in more detail. Inner bracket 14 comprises first key-bolt hole 16, second key bolt hole 16, first pin hole 18 and second pin hole 18. Inner bracket 14 should be made of hard metal that is resistant to puncture such as steel, stainless steel or brass. Notably, steel would provide a more economical solution, but would be subject to rust. Stainless steal would not be subject to rust, but would be more expensive. Brass would provide additional protection against thieves who choose to use a torch to remove anti-theft lock assembly 10 because brass can rapidly displace heat. Regardless of material chosen, inner bracket 14 can be made with conventional metal working technology.

FIG. 4 shows outer bracket 12 in more detail. Outer bracket 12 comprises third key-bolt hole 16, fourth key bolt hole 16, third pin hole 18 and fourth pin hole 18. Outer bracket 12 should be made of hard metal that is resistant to puncture such as steel, stainless steel or brass for the reasons stated above. Similarly, outer bracket 12 can be made with conventional metal working technology.

FIG. 5 shows a section view of anti-theft lock assembly 10 along line 2-2 in FIG. 1. Outer bracket 16 is mechanically coupled to inner bracket 14 with pin 28 and key bolt 26 as shown above. Here, urinal piping section 24 is shown mechanically coupled to a water source with compression nut 20. Anti-theft lock assembly 10 is designed to rotate around compression nut 20 without having an adequate surface tension to turn compression nut 20. That is, as a user turns anti-theft lock assembly 10, compression nut 20 remains stationary.

FIG. 6 shows one manner of how a user can use anti-theft lock assembly 10. As noted above, the user uses anti-theft lock assembly 10 to protect compression nut 20 which mechanically couples a water source to urinal piping 24. To use the lock a user must permanently fix pin 28 to first pin hole 18 and second pin hole 18, such that the inner bracket remains ambulatory. This can be done in a wide variety of ways using conventional metalworking technology. For instance, a user could weld outer bracket 12 to pin 18 and leave inner bracket 14 ambulatory about pin 18. Other techniques involving soldering and press fitting can be equally effective.

After this a user can compress outer bracket 12 and inner bracket 14 such that first key bolt hole 16, second key bolt hole 16, third key bolt hole 16 and fourth key bolt hole 16 are in alignment. At that point a user can insert key bolt 26 through first key bolt hole 16, second key bolt hole 16, third key bolt hole 16 and fourth key bolt hole 16 and then activate key bolt 26 to complete the locking mechanism.

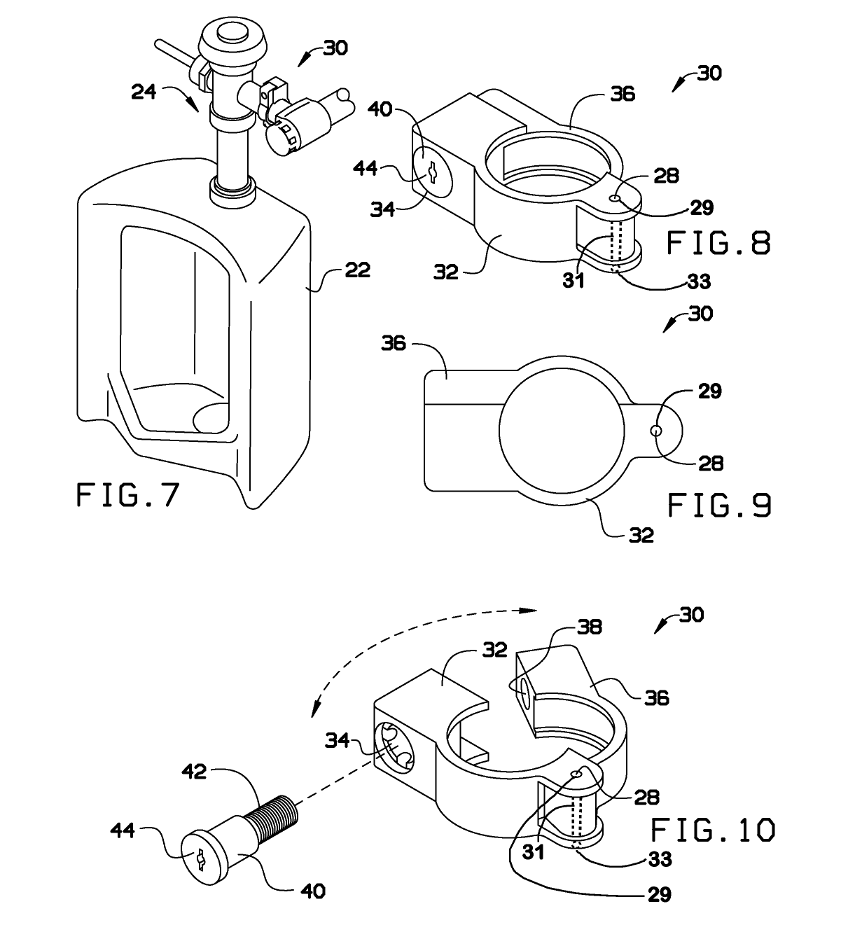

FIG. 7 shows a perspective view of an alternate embodiment of the invention in use. Urinal 22 is connected to a water source by urinal piping 24. The owner can prevent thieves from stealing urinal piping 24 by covering compression nut 20 (not shown) with anti-theft lock assembly 30 as shown in FIG. 8.

FIG. 8 shows anti-theft lock assembly 30 in more detail. Anti-theft lock assembly 30 comprises outer bracket 32 which is mechanically coupled to inner bracket 36 by a hinge mechanism and a locking mechanism. Outer bracket 32 further comprises a first lock hole, which is key bolt hole 34, a first pin hole and a second pin hole. Inner bracket 36 further comprises a second key bolt hole, which is interference shaft hole 38 (not shown) and a third pin hole. A user can complete the hinge mechanism by inserting a key lock, barrel lock 40 into key bolt hole 34 and inserting a key into key hole 44 as shown in FIG. 10 below.

FIG. 9 shows anti-theft lock assembly 30 from a top view. As noted above, outer bracket 32 is mechanically coupled to inner bracket 36 by a hinge mechanism and a locking mechanism. To complete the locking mechanism a user can insert pin 28 through the first pin hole, the second pin hole and third pin hole such that the pin is permanently fixed to the first pin hole and the second pin hole while the inner bracket remains ambulatory. Much like pin 18, pin 28 can mechanically couple outer bracket 32 to inner bracket 36 in a wide variety of ways. For instance, a user could weld outer bracket 32 to pin 18 and leave inner bracket 36 ambulatory about pin 28. Other techniques involving soldering and press fitting can be equally effective to complete the locking mechanism.

FIG. 10 shows one manner of using anti-theft lock assembly 30. As noted above, outer bracket 32 is mechanically coupled to inner bracket 36 by pin 28. Inner bracket 36, further comprises a third lock hole, which is interference shaft hole 38. Outer bracket 32, further comprises key bolt hole 34. To use anti-theft lock assembly 30, a user inserts outer bracket 32 and inner bracket 36 over compression nut 20, and then compresses outer bracket 32 to inner bracket 36 as shown. To complete the mechanical couple, the user inserts barrel lock 40 into key bolt hole 34. Barrel lock 40 further comprises barrel lock male thread 42 which can be mechanically coupled to interference shat hole 38 by inserting a key into key hole 44 in a manner well known in the art.

1: An anti-theft lock assembly comprising,
an outer bracket mechanically coupled to an inner bracket by a hinge mechanism and a locking mechanism;
where the outer bracket comprises a first pin hole, a second pin hole, and a first lock hole;
where the inner bracket comprises a third pin hole, and a third lock hole;
where the hinge mechanism further comprises inserting a pin through the first pin hole, the second pin hole and the third pin hole and permanently fixing the pin to the first pin hole and the second pin hole such that the inner bracket remains ambulatory; and
where the locking mechanism further comprises inserting a key lock through the first lock hole into a second lock hole and activating the key lock.

2: The anti-theft lock assembly of claim 1, further comprising where the outer bracket further comprises the second lock hole; and
where the inner bracket further comprises a fourth pin hole and a fourth lock hole.

3: The anti-theft lock assembly of claim 1, further comprising were the first lock hole is a key bolt hole;
where the third lock hole is an interference shaft hole; and
where the key lock is a barrel lock.
